(19) United States
(12) Patent Application Publication
(10) Pub. No.: US 2017/0369821 A1
(43) Pub. Date: Dec. 28, 2017

(54) CLEANING COMPOSITION FOR REMOVING OXIDE AND METHOD OF CLEANING USING THE SAME

(71) Applicant: Samsung Display Co., Ltd., Yongin-si (KR)

(72) Inventors: Sungsoon Im, Yongin-si (KR); Kyuhwan Hwang, Yongin-si (KR); Youngmin Moon, Yongin-si (KR); Minho Moon, Yongin-si (KR); Inho Kong, Cheonan-si (KR); Changsub Kim, Cheonan-si (KR); Hotae Kim, Asan-si (KR); Jaehwan Jin, Gumi-si (KR); Donguk Hwang, Cheonan-si (KR)

(21) Appl. No.: 15/632,170

(22) Filed: Jun. 23, 2017

(30) Foreign Application Priority Data
Jun. 24, 2016 (KR) 10-2016-0079293
Oct. 27, 2016 (KR) 10-2016-0141171

(51) Int. Cl. C11D 11/00; C11D 1/14; C11D 3/04; C11D 3/20; B08B 3/08

(52) U.S. Cl. CPC C11D 11/0047; C11D 3/2086; C11D 3/2075; B08B 3/08; C11D 3/042; C11D 1/143; C11D 3/046

(57) ABSTRACT

The present disclosure relates to a cleaning composition for removing an oxide including one selected from an organic acid, an inorganic acid, and any combination thereof; one selected from an organic salt, an inorganic salt, and any combination thereof; an oxidizing agent; a surfactant; and water, and a method of cleaning using the cleaning composition.

### CLAIM OF PRIORITY

This application makes reference to, incorporates the same herein, and claims all benefits accruing under 35 U.S.C. §119 from applications earlier filed in the Korean Intellectual Property Office on 24 Jun. 2016 and there duly assigned Serial No. 10-2016-0079293, and on 27 Oct. 2016 and there duly assigned Serial No. 10-2016-0141171.

### BACKGROUND OF THE INVENTION

### Field of the Invention

One or more embodiments relate to a cleaning composition for removing an oxide and a method of cleaning using the cleaning composition.

### Description of the Related Art

Organic light-emitting devices (OLEDs) are self-emission devices that have wide viewing angles, high contrast ratios, and short response times. In addition, OLEDs exhibit excellent luminance, driving voltage, and response speed characteristics, and produce full-color images.

OLEDs may have a structure in which a first electrode, an organic layer, and a second electrode are stacked on a substrate in this stated order. This stacked structure of OLEDs may be formed by using a deposition method using a mask. In other words, the organic layer may be fine-patterned by a deposition method using a metal mask, for example, a fine metal mask (FMM). However, since the first electrode and the second electrode are not to be fine-patterned, the first electrode and the second electrode may be formed by a deposition method using an open mask.

In general, the FMM may be formed by processing a mask base material by using a wet etching process or lasering process. A mask may introduce contaminants during a deposition process, and therefore, cleaning of the mask is required. During the wet etching process, impurities may be removed by rinsing the mask base material with a conventional cleaning solution, such as distilled water or alcohol.

However, when processing a mask base material by using a lasering process, an oxide, which is naturally formed when irradiating the mask base material with a laser, is not removed by the conventional cleaning solution. Thus, a problem exists in that the oxide remains on the mask base material.

### SUMMARY OF THE INVENTION

One or more embodiments include a cleaning composition for removing an oxide, the cleaning composition having a cleaning ability excellent enough to shorten a cleaning time and sustain a cleaning effect for a long time, while not damaging a mask base material.

One or more embodiments include a method of cleaning by using the cleaning composition for removing an oxide.

Additional aspects will be set forth in part in the description which follows and, in part, will be apparent from the description, or may be learned by practice of the presented embodiments.

According to one or more embodiments, a cleaning composition for removing an oxide includes: one selected from an organic acid, an inorganic acid, and any combination thereof; one selected from an organic salt, an inorganic salt, and any combination thereof; an oxidizing agent; a surfactant; and water.

According to one or more embodiments, a method of cleaning includes: preparing a mask base material having an oxide; and performing a first cleaning by contacting the cleaning composition for removing an oxide with the mask base material to remove an oxide of the mask base material.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a photograph of a test sample prepared according to Preparation Example 2, the photograph being captured using a digital camera and showing one side of a test sample to which a laser was irradiated;

FIGS. 2 to 11 are each photographs of test samples cleaned according to an example embodiment, the photograph having been captured using a digital camera and showing one side of a test sample to which a laser was irradiated; and

FIGS. 12 to 14 are each images of test samples cleaned according to an example embodiment, wherein the images were captured using a scanning electron microscope and shows one side of the test sample to which a laser was not irradiated.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, a cleaning composition for removing an oxide and a method of cleaning using the cleaning composition according to example embodiments will be explained in detail with reference to the attached drawings. However, the present inventive concept is not limited thereto, and all differences within the scope should be construed as being included in the inventive concept.

It will be understood that although the terms “first,” “second,” etc. may be used herein to describe various components, these components should not be limited by these terms. These components are only used to distinguish one component from another.

In the present specification, it is to be understood that the terms such as “including,” “having,” and “comprising” are intended to indicate the existence of the features or components disclosed in the specification, and are not intended to preclude the possibility that one or more other features or components may exist or may be added.

As used herein, the term “organic acid” indicates an organic compound that is acidic (i.e., has a pH lower than 7) in an aqueous environment, for example, an organic compound including an acid functional group, such as a carboxyl group (—COOH), a sulfonic acid group (—SO₃H), an aryl group substituted with a hydroxy group (—ArOH) (wherein, Ar indicates an aryl group, such as a phenyl group), or a mercapto group (—SH).

As used herein, the term an “inorganic acid” indicates a compound that is acidic (i.e., has a pH lower than 7) in an aqueous environment, wherein an acid group containing a non-metal element, such as chlorine, nitrogen, sulfur, or phosphorus, is bound to a hydrogen atom.

Hereinafter, a cleaning composition for removing an oxide and a method of cleaning using the cleaning composition according to an example embodiment will be explained in detail.

According to an example embodiment, a cleaning composition for removing an oxide includes: one selected from an organic acid, an inorganic acid, and any combination thereof; one selected from an organic salt, an inorganic salt, and any combination thereof; an oxidizing agent; a surfactant; and water.

The acid in the cleaning composition for removing an oxide may react with an oxide described below, thereby removing the oxide.

The acid may be used in a sufficient amount to selectively remove an oxide. For example, an amount of the acid may be in a range of about 0.1 wt % to about 50 wt % based on 100 wt % of the cleaning composition for removing an oxide. In some embodiments, an amount of the acid may be, based on 100 wt % of the cleaning composition for removing an oxide, in a range of about 0.1 wt % to about 40 wt %, in some embodiments, about 0.1 wt % to about 35 wt %, in some embodiments, about 0.1 wt % to about 30 wt %, and in some embodiments, about 0.1 wt % to about 25 wt %.

When an amount of the acid is within these ranges, the cleaning composition for removing an oxide may have an excellent cleaning ability, while not damaging a base material.

According to an embodiment, the acid may be an organic acid.

For example, the organic acid may include a carboxylic acid having a carboxyl group (—COOH). In particular, the organic acid may be a carboxylic acid having at least one carboxyl group and 1 to 10 carbon atoms, but embodiments are not limited thereto.

For example, the organic acid may include one carboxylic acid selected from acetic acid, formic acid, propionic acid, butyric acid, isobutyric acid, valeric acid, ethylmethyl acetic acid, trimethyl acetic acid, succinic acid, adipic acid, citric acid, oxalic acid, lactic acid, tartaric acid, malic acid, ascorbic acid, malonic acid, and any combination thereof.

Further, the organic acid may include a sulfonic acid having a sulfonic acid group (—SO₃H). For example, the organic acid may include one sulfonic acid selected from a methane sulfonic acid, an ethane sulfonic acid, an n-propane sulfonic acid, an iso-propane sulfonic acid, an n-butane sulfonic acid, and any combination thereof.

The organic acid may be used alone or in a combination of at least two thereof.

In some embodiments, the acid may be an inorganic acid.

The inorganic acid may include one acid selected from sulfuric acid, hydrochloric acid, phosphoric acid, nitric acid, perchloric acid, and any combination thereof, but embodiments are not limited thereto.

The inorganic acid may be used alone or in a combination of at least two thereof.

The salt in the cleaning composition for removing an oxide may enhance the ability of the cleaning composition to remove the oxide.

For example, the salt may include at least one of an inorganic salt including one of a sulfate, a phosphate, a hydrochloride, a nitrate, or any combination thereof; and an organic salt including at least one of a carboxylate, a sulfonate, or any combination thereof.

Particularly, the salt may include an inorganic salt including one selected from sodium sulfate, potassium sulfate, magnesium sulfate, ammonium sulfate, and any combination thereof.

In some embodiments, the salt may include an organic salt including one selected from sodium acetate, potassium acetate, sodium citrate, potassium citrate, and any combination thereof.

For example, an amount of the salt may be in a range of about 0.1 wt % to about 35 wt %, based on 100 wt % of the cleaning composition for removing an oxide. In some embodiments, an amount of the salt may be, based on 100 wt % of the cleaning composition for removing an oxide, in a range of about 0.1 wt % to about 30 wt %, in some embodiments, about 0.1 wt % to about 25 wt %, in some embodiments, about 0.1 wt % to about 20 wt %, and in some embodiments, about 0.1 wt % to about 15 wt %.

When an amount of the salt is within these ranges, the cleaning composition for removing an oxide may have an excellent cleaning ability, while not damaging a base material.

The oxidizing agent present in the cleaning composition for removing an oxide may speed up a rate of reduction by lowering an activation energy of the oxide. In this regard, the cleaning composition for removing an oxide may have an improved cleaning ability and an increased lifespan.

For example, the oxidizing agent may include one selected from oxygenated water, potassium permanganate, ozonated water, sodium nitrate, ammonium nitrate, and any combination thereof.

An amount of the oxidizing agent may be in a range of about 1 wt % to about 60 wt %, based on 100 wt % of the cleaning composition for removing an oxide. In some embodiments, an amount of the oxidizing agent may be, based on 100 wt % of the cleaning composition for removing an oxide, in a range of about 1 wt % to about 55 wt %, in some embodiments, about 1 wt % to about 50 wt %, in some embodiments, about 1 wt % to about 45 wt %, and in some embodiments, about 1 wt % to about 40 wt %.

When an amount of the oxidizing agent is within these ranges, the cleaning composition for removing an oxide may have an excellent cleaning ability, while not damaging a base material.

Due to the surfactant present in the cleaning composition used for removing an oxide, an oxide that has been removed from a surface of the base material may be prevented from reattaching thereto.

The surfactant may include one surfactant selected from an anionic surfactant including at least one of an alkyl sulfate, an alkyl ether sulfate, an alkyl sulfonate, an alkyl ether sulfonate, an alkyl phosphate, an alkyl ether phosphate, an alkyl carbonate, an alkyl ether carbonate, and any combination thereof; and

a nonionic surfactant including at least one of a polyoxyethylene alkyl ether, a polyoxyethylene fatty acid ester, polyoxyethylene alkyl phenol ether, sorbitan fatty acid ester, polyoxyethylene sorbitan fatty acid ester, or sucrose fatty acid ester.

For example, the nonionic surfactant may include one nonionic surfactant selected from a lauryl sulfonate, an isotridecyl sulfonate, a naphthalene sulfonate, a dibutyl naphthyl sulfonate, a nonyl benzene sulfonate, a dodecyl benzene sulfonate, an isotridecyl benzene sulfonate, a lauryl sulfate, an isotridecyl sulfate, a stearyl sulfate, and any combination thereof, but embodiments are not limited thereto.

The nonionic surfactant may not be dissociated into ions in an aqueous solution, but may be dissolved. The nonionic surfactant may be a polymer wherein a hydrophobic monomer and a hydrophilic monomer are polymerized.

The nonionic surfactant lowers the surface tension of water, so that the surface on which an oxide forms may be easily wet. The nonionic surfactant also lowers a binding strength between a surface and an oxide, so that the oxide may be easily removed from the surface. The oxide removed from the surface may be surrounded by surfactant molecules, and thus, the surfactant molecules may be easily dispersed in a cleaning solution to enhance the ability of the cleaning composition to remove the oxide.

For example, an amount of the surfactant may be in a range of about 0.1 wt % to about 15 wt %, based on 100 wt % of the cleaning composition for removing an oxide. In some embodiments, an amount of the surfactant may be, based on 100 wt % of the cleaning composition for removing an oxide, in a range of about 0.1 wt % to about 10 wt %, in some embodiments, about 0.1 wt % to about 5 wt %, and in some embodiments, about 0.1 wt % to about 3 wt %.

When an amount of the salt is within these ranges, the cleaning composition for removing an oxide may have an excellent cleaning ability, while preventing the oxide that has been removed from the surface of the base material from reattaching to the same.

The cleaning composition for removing an oxide may include water as well as above-described components, with respect to 100 wt % of the cleaning composition for removing an oxide. The water may be deionized water or ultrapure water having substantially decreased levels of impurities.

The cleaning composition may be capable of reducing one oxide of a metal selected from iron (Fe), cobalt (Co), chromium (Cr), manganese (Mn), nickel (Ni), titanium (Ti), molybdenum (Mo), a steel use stainless (SUS) alloy, an Inconel alloy, a Kovar alloy, an Invar alloy, and any combination thereof.

For example, among the above described metals, an oxide of Fe, Ni, or Co may be, although not limited thereto, reduced according to the following Equation 1:

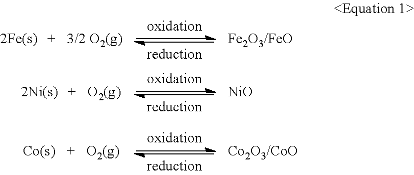

The cleaning composition for removing an oxide according to an embodiment may include the acid, the salt, the oxidizing agent, and the surfactant, and thus, the cleaning composition may induce reduction reaction of the oxide and control a reaction rate with the oxide. As a result, the oxide may be effectively removed. In addition, the cleaning composition for removing an oxide may prevent an oxide, which remains in the cleaning composition after the cleaning, from reattaching to a surface. In addition, the cleaning composition for removing an oxide has a cleaning ability excellent enough to shorten a period of cleaning time and sustains a cleaning effect for a long time.

The cleaning composition for removing an oxide may be mixed or prepared by using a known method. For example, the cleaning composition for removing an oxide may be prepared by mixing the acid, the salt, the oxidizing agent, the surfactant, and water such that a total weight of the components is 100 wt %. In addition, the cleaning composition for removing an oxide may include other components within a range that does not affect adversely. The above-described components may be mixed with in a random order provided that they do not cause a particular problem, such as an undesired reaction or forming of a precipitate. Any two of the components may be pre-mixed together, and the other components may be added to the mixture thereafter. Alternatively, all of the components may be mixed together at the same time.

Hereinafter, a method of cleaning according to an example embodiment will be described in detail.

The method of cleaning may include preparing a mask base material having an oxide; and performing a first cleaning by contacting the cleaning composition for removing the oxide with the mask base material to remove an oxide of the mask base material.

The mask base material may include one metal selected from Fe, Co, Cr, Mn. Ni, Ti, Mo, an SUS alloy, an Inconel alloy, a Kovar alloy, an Invar alloy, and any combination thereof, but embodiments are not limited thereto.

For example, the mask base material may be an Invar alloy. Principal components of the Invar alloy are Fe and Ni, and the Invar alloy is advantageous in that the Invar alloy has less thermal expansion compared to SUS alloy, and its tension does not decrease in a substantial degree even at a high temperature.

The mask base material may be processed by laser irradiation.

For example, the mask base material may be processed by laser irradiation with an energy density in a range of about 50 mJ/cm² to about 5,000 mJ/cm². In particular, the mask base material may be processed by laser irradiation with energy density in a range of about 200 mJ/cm² to about 1,000 mJ/cm².

The mask base material may be processed by laser irradiation for about 1 minute to about 1,440 minutes. For example, the mask base material may be processed by laser irradiation for about 60 minutes to about 720 minutes.

The oxide may be naturally formed when irradiating the mask base material with a laser.

For example, the oxide may be an oxide of a metal selected from Fe, Co, Cr, Mn, Ni, Ti, Mo, an SUS alloy, an Inconel alloy, a Kovar alloy, an Invar alloy, and any combination thereof, wherein the oxide of the metal naturally is formed on the mask base material when the mask base material is irradiated with a laser.

For example, the oxide may be an oxide of an Invar alloy, but embodiments are not limited thereto.

For example, the mask base material may include an Invar alloy and an oxide of an Invar alloy, but embodiments are not limited thereto.

The cleaning composition for removing an oxide may be understood by referring to the detailed description provided herein.

In the first cleaning, the oxide may be removed by contacting the cleaning composition for removing an oxide with the mask base material to reduce the oxide and separate the reduced oxide from the mask base material.

The first cleaning, although not limited thereto, may be performed by contacting the cleaning composition for removing an oxide with the mask base material by using a spray method that includes spraying the cleaning composition for removing an oxide on the mask material, a spin method that includes high speed rotating the mask base material after contacting the cleaning composition with the mask base material, or a dipping method that includes immersing the mask base material into a cleaning bath filled with the cleaning composition for removing an oxide.

For example, the first cleaning may be performed by using a dipping method in a temperature range of about 10° C. to about 50° C. for about 60 minutes to about 1,440 minutes. When the first cleaning is performed within these temperature and time ranges, a cleaning ability to remove an oxide may be improved, and damage to the mask base material may be minimized.

In some embodiments, the method of cleaning may further include at least one of a second cleaning using a cleaning composition including a first alcohol, a surfactant, and water; a third cleaning using distilled water; and a fourth cleaning using a second alcohol.

For example, the method of cleaning may include performing the first cleaning, followed by performing a second cleaning, third cleaning, and fourth cleaning consecutively.

For example, the method of cleaning may include performing the first cleaning, followed by performing the third cleaning and fourth cleaning consecutively.

For example, the method of cleaning may include performing the first cleaning, followed by performing a second cleaning.

The second cleaning may prevent any oxides removed from the mask base material and remained in the cleaning composition during the first cleaning from re-attaching to the mask base material.

The second cleaning may be performed by using a described method, such as a spray method, a spin method, or a dipping method.

For example, the method of cleaning may include the second cleaning performed by using a dipping method in a temperature range of about 10° C. to about 50° C. for about 60 minutes to about 120 minutes.

In the cleaning composition in the second cleaning, an amount of the first alcohol may be in a range of about 5 wt % to about 50 wt %, and an amount of the surfactant may be in a range of about 0.1 wt % to about 10 wt %, based on 100 wt % of the cleaning composition in the second cleaning. For example, in the cleaning composition in the second cleaning, an amount of the first alcohol may be in a range of about 5 wt % to about 25 wt %, and an amount of the surfactant may be in a range of about 0.1 wt % to about 5 wt %, based on 100 wt % of the cleaning composition in the second cleaning.

When the amount of each of the first alcohol and surfactant is within these ranges, a removed oxide may be prevented from being reattached.

When the method of cleaning further includes the second cleaning, a weight ratio of the cleaning composition in the second cleaning to the cleaning composition for removing an oxide in the first cleaning may be in a range of about 1:1 to about 2:1, but embodiments are not limited thereto.

The surfactant included in the cleaning composition in the second cleaning may include one surfactant selected from an anionic surfactant including at least one of an alkyl sulfate, an alkyl ether sulfate, an alkyl sulfonate, an alkyl ether sulfonate, an alkyl phosphate, an alkyl ether phosphate, an alkyl carbonate, an alkyl ether carbonate, and any combination thereof, and

a nonionic surfactant including at least one of a polyoxyethylene alkyl ether, a polyoxyethylene fatty acid ester, polyoxyethylene alkyl phenol ether, sorbitan fatty acid ester, polyoxyethylene sorbitan fatty acid ester, or sucrose fatty acid ester.

For example, the surfactant included in the cleaning composition in the second cleaning may include one nonionic surfactant selected from a lauryl sulfonate, an isotridecyl sulfonate, a naphthalene sulfonate, a dibutyl naphthyl sulfonate, a nonyl benzene sulfonate, a dodecyl benzene sulfonate, an isotridecyl benzene sulfonate, a lauryl sulfate, an isotridecyl sulfate, a stearyl sulfate, and any combination thereof, but embodiments are not limited thereto.

The surfactant included in the cleaning composition in the second cleaning may be identical to or different from the surfactant included in the cleaning composition for removing an oxide in the first cleaning.

The first alcohol and the second alcohol may include at least one selected from aliphatic hydrocarbon groups having at least one hydroxy group (—OH) and 1 to 10 carbon atoms.

For example, the first alcohol and the second alcohol may each independently include one alcohol selected from methanol, ethanol, pentanol, 2-methyl-2-butanol, 3-methyl-2-butanol, n-propanol, iso-propanol, butanol, iso-butyl alcohol, 2-butanol, 2-methyl-2-propanol, hexanol, cyclohexanol, benzyl alcohol, propyl alcohol, ethylene glycol, propylene glycol, diethylene glycol, glycerine, dipropylene glycol, and any combination thereof.

The first alcohol and the second alcohol may be identical to or different from each other. For example, the first alcohol and the second alcohol may each be iso-propanol.

In some embodiments, the method of cleaning may include a third cleaning, and the third cleaning may be performed in a temperature range of about 10° C. to about 50° C. for about 1 minutes to about 60 minutes.

When the third cleaning is performed within these temperature and time ranges, a cleaning ability to remove an oxide may substantially increase.

For example, the method of cleaning may include the third cleaning, and the third cleaning may be performed via ultrasonic cleaning of the mask base material at a frequency of 50 kHz or less by using distilled water.

When the method of cleaning includes the third cleaning, a weight ratio of the distilled water in the third cleaning to the cleaning composition for removing an oxide in the first cleaning may be in a range of about 1:1 to 2:1.

When a weight ratio of the distilled water in the third cleaning to the cleaning composition for removing an oxide in the first cleaning is within this range, a cleaning ability to remove an oxide may substantially increase.

The method of cleaning may include a fourth cleaning, and the fourth cleaning may be performed in a temperature range of about 10° C. to about 50° C. for about 1 minutes to about 60 minutes.

When the fourth cleaning is performed within these temperature and time ranges, a cleaning ability to remove an oxide may substantially increase.

When the method of cleaning includes the fourth cleaning, a weight ratio of the second alcohol in the fourth cleaning to the cleaning composition for removing an oxide in the first cleaning may be in a range of about 1:1 to 2:1.

When a weight ratio of the distilled water in the fourth cleaning to the cleaning composition for removing an oxide in the first cleaning is within this range, a cleaning ability to remove an oxide may substantially increase.

Hereinafter, the cleaning composition and the method of cleaning will be described in detail with reference to Examples. However, Examples are to describe the inventive concept in more detail, and thus, the scope of the inventive concept is not limited thereto.

### EXAMPLES

### Preparation of a Cleaning Composition for Removing an Oxide

### Preparation Example 1-1

A cleaning composition for removing an oxide was prepared by stirring an acid (10 wt % of citric acid), an oxidizing agent (50 wt % of oxygenated water), and water for 4 hours at room temperature.

### Preparation Examples 1-2 to 1-4

Cleaning compositions for removing an oxide of Preparation Examples 1-2 to 1-4 were each prepared in the same manner as in Preparation Example 1-1, except that the acid and the oxidizing agent were changed to those listed in Table 1.

### Preparation Example 1-5

A cleaning composition for removing an oxide was prepared by mixing an acid (5 wt % of citric acid), a salt (5 wt % of a sulfate), an oxidizing agent (10 wt % of oxygenated water), a surfactant (1 wt % of a lauryl sulfonate), and water.

### Preparation Examples 1-6 to 1-8

Cleaning compositions for removing an oxide of Preparation Examples 1-6 to 1-8 were each prepared in the same manner as in Preparation Example 1-5, except that the acid, the salt, the oxidizing agent, and the surfactant were changed to those listed in Table 1.

### Preparation Example 1-9

A cleaning composition for removing an oxide was prepared by mixing an acid (10 wt % of sulfuric acid), a salt (5 wt % of a citrate), an oxidizing agent (50 wt % of oxygenated water), and water.

### Preparation Example 1-10

A cleaning composition for removing an oxide was prepared in the same manner as in Preparation Example 1-10, except that nitric acid was used instead of the sulfuric acid.

### Preparation Example 1-11

A cleaning composition for removing an oxide was prepared by mixing an acid (10 wt % of citric acid), a salt (5 wt % of a citrate), an oxidizing agent (10 wt % of oxygenated water), a surfactant (1 wt % of a lauryl sulfonate), and water.

### Preparation Examples 1-12 to 1-14

Cleaning compositions for removing an oxide of Preparation Examples 1-12 to 1-14 were each prepared in the same manner as in Preparation Example 1-11, except that the acid, the salt, the oxidizing agent, and the surfactant were changed to those listed in Table 1.

TABLE 1

| | Acid | | | | Salt | | | | | | | | |
|---|---|---|---|---|---|---|---|---|---|---|---|---|---|
| | Organic | | Inorganic | | Organic | | Inorganic | | | | | | |
| Preparation | acid | | acid | | salt | | salt | | Oxidizing agent | | Surfactant | | Water |
| Example | | Amount | | Amount | | Amount | | Amount | | Amount | | Amount | Amount |
| No. | Type | (wt %) | Type | (wt %) | Type | (wt %) | Type | (wt %) | Type | (wt %) | Type | (wt %) | (wt %) |
| 1-1 | Citric acid | 10 | — | — | — | — | — | — | Oxygenated | 50 | — | — | 40 |
| | | | | | | | | | water | | | | |
| 1-2 | Tartaric | 10 | — | — | — | — | — | — | Oxygenated | 50 | — | — | 40 |
| | acid | | | | | | | | water | | | | |
| 1-3 | Oxalic | 10 | — | — | — | — | — | — | Oxygenated | 50 | — | — | 40 |
| | acid | | | | | | | | water | | | | |
| 1-4 | Succinic | 10 | — | — | — | — | — | — | Oxygenated | 50 | — | — | 40 |
| | acid | | | | | | | | water | | | | |
| 1-5 | Citric acid | 5 | — | — | — | — | Sulfate | 5 | Oxygenated | 10 | Lauryl sulfonate | 1 | 79 |
| | | | | | | | | | water | | | | |
| 1-6 | Tartaric | 5 | — | — | — | — | Sulfate | 5 | Oxygenated | 10 | Lauryl sulfonate | 1 | 79 |
| | acid | | | | | | | | water | | | | |
| 1-7 | Oxalic | 5 | — | — | — | — | Sulfate | 5 | Oxygenated | 10 | Polyoxyethylene | 1 | 79 |
| | acid | | | | | | | | water | | glycol | | |
| 1-8 | Succinic | 5 | — | — | — | — | Sulfate | 5 | Oxygenated | 10 | Polyoxyethylene | 1 | 79 |
| | acid | | | | | | | | water | | glycol | | |
| 1-9 | — | — | Sulfuric | 5 | Citric | 5 | — | — | Oxygenated | 50 | — | — | 40 |
| | | | acid | | acid | | | | water | | | | |
| | | | | | salt | | | | | | | | |
| 1-10 | — | — | Nitric | 5 | Citric | 5 | — | — | Oxygenated | 50 | — | — | 40 |
| | | | acid | | acid | | | | water | | | | |
| | | | | | salt | | | | | | | | |
| 1-11 | Citric acid | 5 | — | — | Citric | 5 | — | — | Oxygenated | 10 | Lauryl sulfonate | 1 | 79 |
| | | | | | acid | | | | water | | | | |
| | | | | | salt | | | | | | | | |
| 1-12 | Oxalic | 5 | — | — | Citric | 5 | — | — | Oxygenated | 10 | Lauryl sulfonate | 1 | 79 |
| | acid | | | | acid | | | | water | | | | |
| | | | | | salt | | | | | | | | |
| 1-13 | Citric acid | 10 | — | — | — | — | — | — | Potassium | 10 | Polyoxyethylene | 1 | 79 |
| | | | | | | | | | permanganate | | glycol | | |
| 1-14 | Oxalic | 10 | — | — | — | — | — | — | Ammonium | 10 | Polyoxyethylene | 1 | 79 |
| | acid | | | | | | | | nitrate | | glycol | | |

### Preparation of a Test Sample

### Preparation Example 2

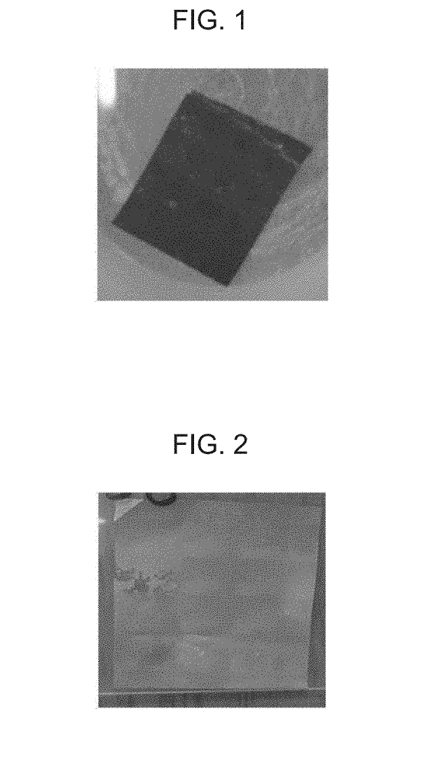

An Invar sheet (width*length*thickness: 10 cm*10 cm*30 μm) was placed on a stage in a laser patterned mask (LPM) system at room temperature and at atmospheric pressure, a portion of the Invar sheet was lasered by using an LPM optical system to thereby form square-like holes (wherein a width and a length are each 40 μm) on the portion of the Invar sheet. As a result, the Invar sheet of which a portion was lasered (hereinafter, referred to as a ‘test sample’) was obtained. The lasered portion of the test sample was captured using a digital camera (model name: VLUU ST70, manufacturer: Samsung), and the result thereof is shown in FIG. 1.

### Evaluation Example 1

### Analysis of a Surface Composition Ratio and a Surface Binder Phase

A surface composition ratio and a surface binder phase of a portion of an unprocessed Invar sheet and the lasered portion of the test sample of Preparation Example 2 were analyzed by using X-ray photoelectron spectroscopy (XPS) (available from Thermo Fisher (UK), product name: Theta Probe), and the results thereof are shown in Table 2.

TABLE 2

| | Oxygen fraction = [O]/{[Fe] + [Ni]} | |
|---|---|---|
| | Etching for 100 seconds | Etching for 200 seconds |
| Unprocessed Invar | 0.16 | 0.14 |
| sheet | | |
| Test sample | 1.00 | 0.90 |

Referring to Table 2, an atomic percentage of oxygen and a binder phase of FeOx and NiOx of the lasered portion of the test sample were higher than those in the unprocessed Invar sheet. Accordingly, it was verified that oxides were formed on the lasered portion of the test sample.

### Cleaning of a Test Sample

### Example 1

1,000 g of the cleaning composition for removing an oxide in Preparation Example 1-1 was poured into a cleaning bath, and the test sample in Preparation Example 2 was immersed in the cleaning composition for removing an oxide in the cleaning bath at a temperature of about 25° C. for a predetermined cleaning time (first cleaning). Here, the term “predetermined cleaning time” as used herein refers to time taken for the oxides formed on the lasered portion of the test sample to change color from dark brown to invar (silver) after being completely removed. Then, the test sample was taken out of the cleaning bath, and was immersed in 300 g of a mixed solution, in which iso-propyl alcohol, lauryl sulfonate, and distilled water are mixed at a weight ratio of 50:5:45, at a temperature of about 35° C. for about 60 minutes (second cleaning). Then, the test sample was taken out, and was dipped into 300 g of distilled water in a cleaning bath for about 10 minutes (third cleaning). Next, the test sample was taken out, and was immersed in 300 g of iso-propyl alcohol in a cleaning bath at a temperature of about 25° C. for about 10 minutes (fourth cleaning), thereby completing the cleaning of the test sample. The lasered portion of the cleaned test sample was captured using a digital camera (model name: VLUU ST70, manufacturer: Samsung), and the result thereof is shown in FIG. 2.

### Examples 2 to 14

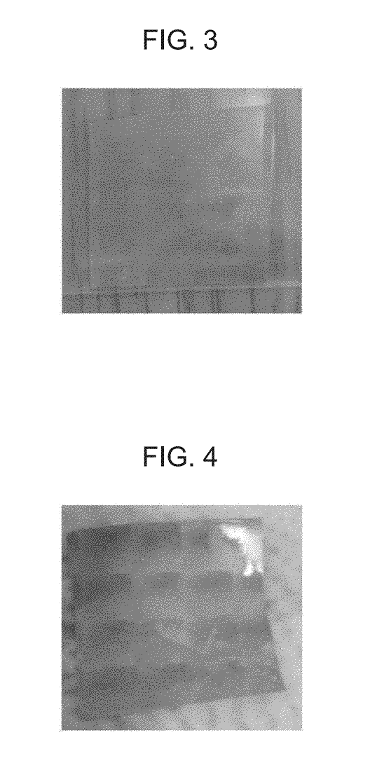

Cleaning of the test sample was completed in the same manner as in Example 1, except that the cleaning composition for removing an oxide in each of Preparation Examples 1-2 to 1-14 was used instead of the cleaning composition for removing an oxide of Preparation Example 1-1. The lasered portion of the cleaned test sample was captured using a digital camera (model name: VLUU ST70, manufacturer: Samsung), and results thereof are shown in each of FIGS. 3 to 14.

The lasered portion of the cleaned test sample of each of Examples 3 and 4 was captured using a digital camera, and results thereof are shown in each of FIGS. 3 and 4.

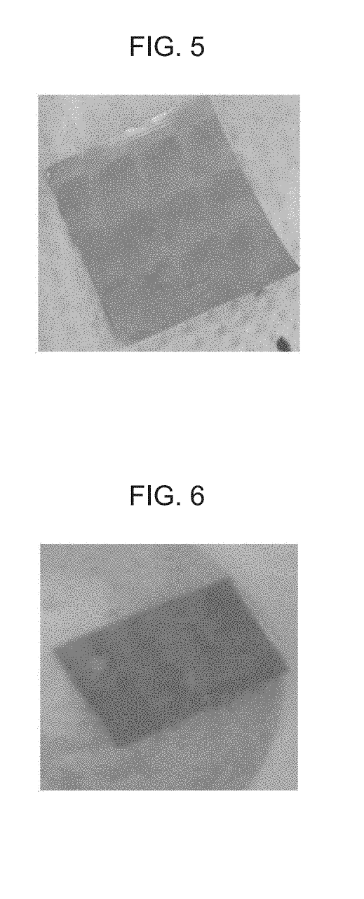

The lasered portion of the cleaned test sample of Example 7 was captured using a digital camera, and a result thereof is shown in FIG. 5.

The lasered portion of the cleaned test sample of Example 5 was captured using a digital camera, and a result thereof is shown in FIG. 6. Regarding the cleaned test samples of Examples 6 and 8, similar results are shown in the drawings.

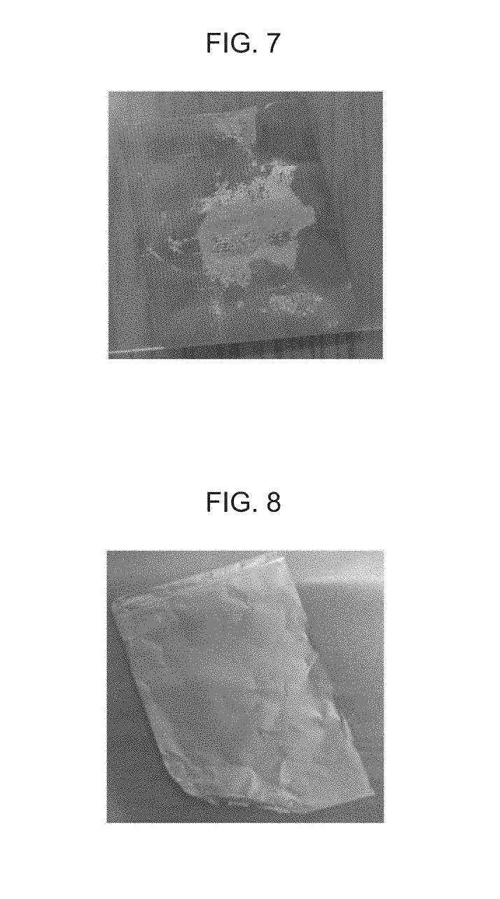

The lasered portion of the cleaned test sample of each of Examples 9 and 10 was captured using a digital camera, and results thereof are shown in each of FIGS. 7 and 8.

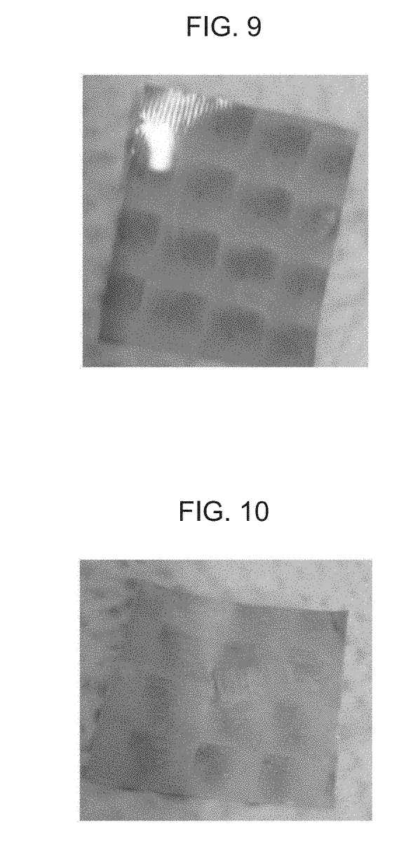

The lasered portion of the cleaned test sample of each of Examples 11 and 12 was captured using a digital camera, and results thereof are shown in each of FIGS. 9 and 10.

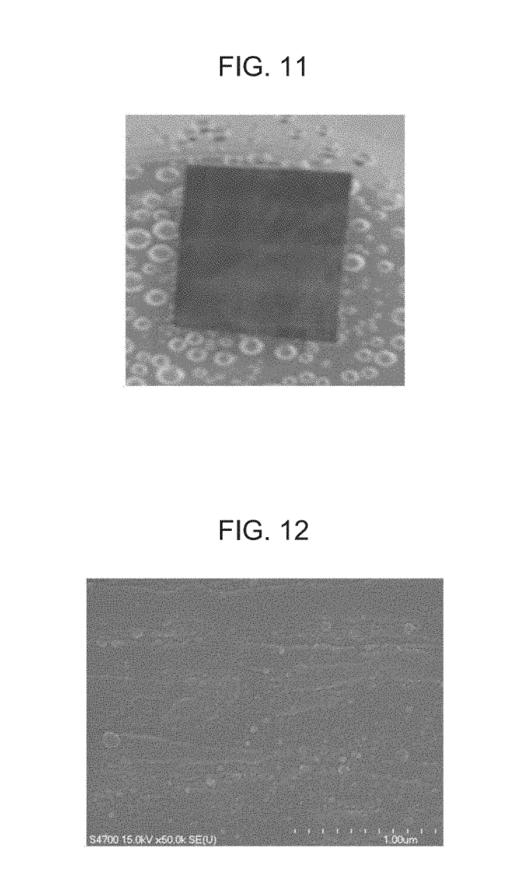

The lasered portion of the cleaned test sample of Example 13 was captured using a digital camera, and a result thereof is shown in FIG. 11. Regarding the cleaned test sample of Example 14, a similar result is shown in the drawing.

### Evaluation Example 2

### Evaluation of Oxide Cleaning Ability

A cleaning time during first cleaning was measured in Examples 1 to 14, and according to the following criteria, oxide cleaning ability of the cleaning composition for removing an oxide in each of Preparation Examples 1-1 to 1-14 was evaluated. The results thereof are shown in Table 3.

⊚: Significantly excellent (about 2 hours≦cleaning time≦about 3 hours)

◯: Excellent (about 3 hours<cleaning time≦about 8 hours)

Δ: Normal (about 8 hour <cleaning time≦about 24 hours)

×: Insufficient (about 24 hours<cleaning time)

### Evaluation Example 3

### Evaluation of Corrosion of a Test Sample

A portion of the cleaned test sample to which a laser was not irradiated in each of Examples 1 to 14 was observed using an SEM (manufacturer: Seron Technology, model name: AIS2100, energy beam: 20 kV, magnification: ×1.2 k), and according to the following criteria, the test samples were evaluated to determine whether corrosion thereof had occurred. The results thereof are shown in Table 3.

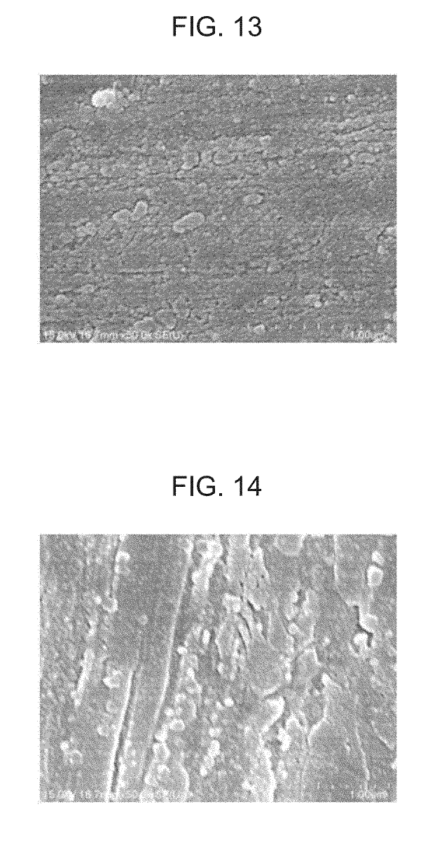

In the evaluation of corrosion of the test samples, a case (◯) where corrosion did not occur on a portion of a test sample to which a laser was not irradiated (◯), a case (Δ) where corrosion slightly occurred on the portion, and a case (×) where corrosion occurred a lot on the portion were considered. FIG. 12 shows an image of the case in which no corrosion occurred, FIG. 13 shows an image of the case in which slight corrosion occurred, and FIG. 14 shows an image of the case in which a lot of corrosion occurred.

TABLE 3

| | | | Corrosion |
|---|---|---|---|
| | Cleaning composition for | Oxide cleaning | of a test |
| | removing an oxide | ability | sample |
| Example 1 | Preparation Example 1-1 | ◯ | ◯ |
| Example 2 | Preparation Example 1-2 | Δ | Δ |
| Example 3 | Preparation Example 1-3 | ⊚ | ◯ |
| Example 4 | Preparation Example 1-4 | Δ | ◯ |
| Example 5 | Preparation Example 1-5 | ◯ | ◯ |
| Example 6 | Preparation Example 1-6 | Δ | Δ |
| Example 7 | Preparation Example 1-7 | ⊚ | ◯ |
| Example 8 | Preparation Example 1-8 | Δ | ◯ |
| Example 9 | Preparation Example 1-9 | ◯ | Δ |
| Example 10 | Preparation Example 1-10 | ◯ | Δ |
| Example 11 | Preparation Example 1-11 | ◯ | ◯ |
| Example 12 | Preparation Example 1-12 | ◯ | ◯ |
| Example 13 | Preparation Example 1-13 | Δ | Δ |
| Example 14 | Preparation Example 1-14 | Δ | Δ |

◯: No corrosion on a portion of a test sample to which a laser was not irradiated
Δ: Slight corrosion on a portion of a test sample to which a laser was not irradiated
X: A lot of corrosion on a portion of a test sample to which a laser was not irradiated

Referring to Table 3, it was verified that the cleaning composition for removing an oxide in each of Preparation Examples 1-1 to 1-14 exhibited a cleaning ability excellent enough to shorten a cleaning time, while not damaging the mask base material (for example, a test sample).

### Evaluation Example 4

### Evaluation of a Sustainable Cleaning Effect

The cleaned test sample in each of Examples 1 to 14 was left at room temperature. Then, oxides were partially formed again on a portion of the test sample, and thus time taken for the portion of the test sample to partially change color to light brown (or dark brown) (hereinafter, referred to as a ‘cleaning effect sustainment time’) was measured. According to the following criteria, sustainability of a cleaning effect of the cleaning composition for removing an oxide in each of Preparation Examples 1-1 to 1-14 was evaluated, and the results thereof are shown in Table 4.

TABLE 4

| | Cleaning composition for | Sustainability of a |
|---|---|---|
| | removing an oxide | cleaning effect |
| Example 1 | Preparation Example 1-1 | ◯ |
| Example 2 | Preparation Example 1-2 | Δ |
| Example 3 | Preparation Example 1-3 | ⊚ |
| Example 4 | Preparation Example 1-4 | Δ |
| Example 5 | Preparation Example 1-5 | ◯ |
| Example 6 | Preparation Example 1-6 | Δ |
| Example 7 | Preparation Example 1-7 | ⊚ |
| Example 8 | Preparation Example 1-8 | Δ |
| Example 9 | Preparation Example 1-9 | Δ |
| Example 10 | Preparation Example 1-10 | Δ |
| Example 11 | Preparation Example 1-11 | ◯ |
| Example 12 | Preparation Example 1-12 | ◯ |
| Example 13 | Preparation Example 1-13 | Δ |
| Example 14 | Preparation Example 1-14 | Δ |

⊚: Significantly excellent (about 5 days ≦ cleaning effect sustainment time)
◯: Excellent (about 3 days ≦ cleaning effect sustainment time < about 5 days)
Δ: Normal (cleaning effect sustainment time < about 3 days)
X: Insufficient (cleaning effect sustainment time < about 1 day)

Referring to Table 4, it was verified that the cleaning composition for removing an oxide in each of Preparation Examples 1-1 to 1-14 sustained a cleaning effect for a long time.

As described above, according to the one or more of the above example embodiments, the cleaning composition for removing an oxide and the method of cleaning by using the cleaning composition for removing an oxide may reduce a cleaning time based on an excellent cleaning ability and sustain a cleaning effect for a long time, while not damaging the mask base material.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A cleaning composition for removing an oxide, comprising:
one selected from an organic acid, an inorganic acid, and any combination thereof;
one selected from an organic salt, an inorganic salt, and any combination thereof;
an oxidizing agent;
a surfactant; and
water.

2. The cleaning composition of claim 1, wherein, based on 100 wt % of the cleaning composition for removing an oxide,
an amount of the acid is in a range of about 0.1 wt % to about 50 wt %,
an amount of the salt is in a range of about 0.1 wt % to about 35 wt %,
an amount of the oxidizing agent is in a range of about 1 wt % to about 60 wt %, and
an amount of the surfactant is in a range of about 0.1 wt % to about 15 wt %.

3. The cleaning composition of claim 1, wherein, based on 100 wt % of the cleaning composition for removing an oxide,
an amount of the acid is in a range of about 0.1 wt % to about 35 wt %,
an amount of the salt is in a range of about 0.1 wt % to about 20 wt %,
an amount of the oxidizing agent is in a range of about 1 wt % to about 55 wt %, and
an amount of the surfactant is in a range of about 0.1 wt % to about 3 wt %.

4. The cleaning composition of claim 1, wherein the acid is an organic acid.

5. The cleaning composition of claim 1, wherein the acid is an inorganic acid.

6. The cleaning composition of claim 1, wherein
the organic acid comprises one carboxylic acid selected from acetic acid, formic acid, propionic acid, butyric acid, isobutyric acid, valeric acid, ethylmethyl acetic acid, trimethyl acetic acid, succinic acid, adipic acid, citric acid, oxalic acid, lactic acid, tartaric acid, malic acid, ascorbic acid, malonic acid, and any combination thereof.

7. The cleaning composition of claim 1, wherein
the inorganic acid comprises one acid selected from sulfuric acid, hydrochloric acid, phosphoric acid, nitric acid, perchloric acid, and any combination thereof.

8. The cleaning composition of claim 1, wherein
the salt comprises at least one salt selected from:
an inorganic salt comprising one selected from sodium sulfate, potassium sulfate, magnesium sulfate, ammonium sulfate, and any combination thereof; and
an organic salt comprising one selected from sodium acetate, potassium acetate, sodium citrate, potassium citrate, and any combination thereof.

9. The cleaning composition of claim 1, wherein the oxidizing agent comprises at least one selected from oxygenated water, potassium permanganate, ozonated water, sodium nitrate, ammonium nitrate, and any combination thereof.

10. The cleaning composition of claim 1, wherein the surfactant comprises at least one surfactant selected from:
an anionic surfactant including one selected from an alkyl sulfate, an alkyl ether sulfate, an alkyl sulfonate, an alkyl ether sulfonate, an alkyl phosphate, an alkyl ether phosphate, an alkyl carbonate, an alkyl ether carbonate, and any combination thereof; and
a nonionic surfactant including one selected from a polyoxyethylene alkyl ether, a polyoxyethylene fatty acid ester, a polyoxyethylene alkylphenyl ether, a sorbitan fatty acid ester, a polyoxyethylene sorbitan fatty acid ester, a sucrose fatty acid ester, and any combination thereof.

11. The cleaning composition of claim 1, wherein the cleaning composition is capable of reducing one oxide of a metal selected from iron (Fe), cobalt (Co), chromium (Cr), manganese (Mn), nickel (Ni), titanium (Ti), molybdenum (Mo), a steel use stainless (SUS) alloy, an Inconel alloy, a Kovar alloy, an Invar alloy, and any combination thereof.

12. A method of cleaning a mask base material of an oxide, the method comprising:
preparing a mask base material comprising an oxide; and
performing a first cleaning by contacting the cleaning composition of claim 1 with the mask base material to remove the oxide.

13. The method of claim 12, wherein the mask base material comprises one metal selected from Fe, Co, Cr, Mn, Ni, Ti, Mo, an SUS alloy, an Inconel alloy, a Kovar alloy, an Invar alloy, and any combination thereof.

14. The method of claim 12, wherein the oxide is formed in response to irradiating the mask base material with a laser.

15. The method of claim 12, wherein the first cleaning comprises contacting the cleaning composition with the mask base material by using a spray method, a spin coating method, or a dipping method.

16. The method of claim 12, wherein the first cleaning comprises using a dipping method in a temperature range of about 10° C. to about 50° C. for about 60 minutes to about 1440 minutes.

17. The method of claim 12, further comprising, after the first cleaning has been completed, at least one of
performing a second cleaning by using a cleaning composition comprising a first alcohol, a surfactant, and water;
performing a third cleaning by using distilled water; and
performing a fourth cleaning by using a second alcohol.

18. The method of claim 17, wherein the second cleaning, the third cleaning, and the fourth cleaning are performed consecutively in this stated order after the first cleaning is complete.

19. The method of claim 18, wherein the second cleaning comprises using a dipping method at a temperature in a range of about 10° C. to about 50° C. for about 60 minutes to about 120 minutes.

20. The method of claim 18, wherein the surfactant in the cleaning composition used in the second cleaning comprises:
one surfactant selected from an anionic surfactant including at least one of an alkyl sulfate, an alkyl ether sulfate, an alkyl sulfonate, an alkyl ether sulfonate, an alkyl phosphate, an alkyl ether phosphate, an alkyl carbonate, an alkyl ether carbonate, and any combination thereof; and
a nonionic surfactant including one of a polyoxyethylene alkyl ether, a polyoxyethylene fatty acid ester, a polyoxyethylene alkyl phenol ether, a sorbitan fatty acid ester, a polyoxyethylene sorbitan fatty acid ester, a sucrose fatty acid ester, and any combination thereof,
and wherein the alcohol independently comprises one alcohol selected from methanol, ethanol, pentanol, 2-methyl-2-butanol, 3-methyl-2-butanol, n-propanol, iso-propanol, butanol, iso-butyl alcohol, 2-butanol, 2-methyl-2-propanol, hexanol, cyclohexanol, benzyl alcohol, propyl alcohol, ethylene glycol, propylene glycol, diethylene glycol, glycerine, dipropylene glycol, and any combination thereof.
